(19) United States
(12) Patent Application Publication
(10) Pub. No.: US 2024/0110088 A1
(43) Pub. Date: Apr. 4, 2024

(54) COOLANTS WITH IMPROVED TEMPERATURE STABILITY

(71) Applicant: BASF SE, Ludwigshafen Am Rhein (DE)

(72) Inventors: Harald Dietl, Ludwigshafen (DE); Roger Sieg, Ludwigshafen (DE); Sebastian Lang, Ludwigshafen (DE); Sandra Schnell, Ludwigshafen (DE); Stephan Bauer, Ludwigshafen (DE)

(73) Assignee: BASF SE, Ludwigshafen Am Rhein (DE)

(21) Appl. No.: 18/551,803

(22) PCT Filed: Mar. 17, 2022
(86) PCT No.: PCT/EP2022/056919

§ 371 Date: Sep. 21, 2023

(30) Foreign Application Priority Data
Mar. 23, 2021 (EP) 21164163.4

(51) Int. Cl. C09K 5/20

(52) U.S. Cl. CPC C09K 5/20

(57) ABSTRACT

Novel aqueous coolants with improved temperature stability contain (A) water; (B) at least one alkylene glycol, alkylene glycol monoalkyl ether, or glycerol; (C) at least one phosphate, carbonate, and/or sulfate in the form of its free acids or its salts; (D) at least one hard water stabilizer; and optionally, further inhibitors and typical coolant constituents. The aqueous coolants are useful, for example, in internal combustion engines.

The present invention describes novel aqueous coolants with improved temperature stability, their production and use.

In modern internal combustion engines, a higher combustion temperature is achieved than in conventional engines, and so in thermal management not only do higher amounts of heat have to be dissipated, but also higher temperature differences between the wall of the combustion chamber and cooling channels occur in the cooling system.

As a result, the aqueous coolant is exposed to a higher temperature and the constituents present are exposed to a greater thermal load, and so a greater demand in terms of thermal load is placed on said coolant.

It has now been found that certain stabilizers which are added to the aqueous coolants in order to complex alkaline earth metal ions in the water used (hard water stabilizers) have relatively high thermal stability and thus reduce or prevent the precipitation of alkaline earth metal compounds. As a result of thermal degradation of the polymer chains, high temperatures at the wall of the cooling channel result in decomposition of conventional poly(meth)acrylates often used as hard water stabilizers, and so alkaline earth metal ions present in the aqueous coolant are no longer kept in solution and form deposits of alkaline earth metal compounds on the wall of the cooling channel, this in turn worsening the heat transfer through the wall between combustion space and cooling channels and the corresponding coefficients of heat transfer.

It was the object of the present invention to provide aqueous coolants that are capable of reducing or preventing deposit formation on the cooling channel walls, especially as a result of precipitation of alkaline earth metal compounds, even at high wall temperatures.

The object was achieved by aqueous coolants comprising
(A) water
(B) at least one alkylene glycol, alkylene glycol monoalkyl ether or glycerol
(C) at least one phosphate, carbonate and/or sulfate in the form of its free acids or its salts, particularly its alkali metal salts, particularly preferably its sodium or potassium salts
(D) at least one hard water stabilizer, optionally further inhibitors and typical coolant constituents
where
the hard water stabilizer (D) is at least one homo- or copolymer that comprises acrylic acid and/or methacrylic acid and/or maleic acid and/or itaconic acid in polymerized form, has a weight-average molecular weight Mw, determined by GPC, of at least 3000 g/mol, preferably at least 3500, particularly preferably at least 4000 and very particularly preferably at least 4500 g/mol, and has a loss of mass in the temperature range of 200° C. to 300° C. of not more than 10%, preferably not more than 8%, particularly preferably not more than 7%, very particularly preferably not more than 5%, in particular not more than 3% and especially not more than 2% by weight.

The loss of mass is measured here by thermogravimetry in the temperature range of 30° C. to 800° C. at a heating rate of 5 K/min in an argon atmosphere at a flow volume of 40 ml/min, the loss of mass in the temperature range of 200° C. to 300° C. being used for the compounds (D) usable according to the invention, where the mass present at 200° C. is taken as the reference value and the decrease with further heating up to 300° C. is taken as the loss of mass.

The use of these specific hard water stabilizers (D) makes it possible to reduce or prevent the precipitation of alkaline earth metal compounds in the coolants, this resulting in less or no deposit formation on the cooling channel walls. Such precipitates of alkaline earth metal compounds may not only form on the cooling channel walls, but the precipitates may also occur at other locations in the cooling system and have an effect there, for example at the circulation pump (coolant pump), at the temperature measurement (thermal switch, temperature probe) or in the cooling channels of the heat exchanger (cooler).

The individual components of the coolants according to the invention are described below:

### Water (A)

The water used in the context of the present invention should be neutral with a pH of around 7; this may, but need not necessarily, be demineralized or distilled water. In order to enable the use of hard water as well, the composition according to the invention comprises at least one hard water stabilizer (D).

The water used may comprise alkaline earth metal ions, for example magnesium, calcium, strontium or barium ions, the latter usually being present at most in traces. Preferably, essentially only magnesium and/or calcium ions are present as hardness formers.

The water used is preferably soft water having a water hardness of not more than 8.4° dH, particularly preferably of not more than 10 and very particularly preferably not more than 12° dH.

It is an advantage of the present invention that it is possible to use water having a water hardness of up to 14° dH, preferably up to 17, particularly preferably up to 20 and even up to 25° dH.

Due to the hardness formers, the water used in the coolant is the usual source for the carbonate and/or sulfate present in the coolant as component (C).

It is an advantage of the coolants according to the invention that it is not necessary to use demineralized or distilled water in order to reduce or prevent precipitates of alkaline earth metal compounds.

Accordingly, the present invention provides a method for reducing or preventing precipitates of alkaline earth metal compounds from phosphate-, carbonate- and/or sulfate-containing, aqueous coolants by adding at least one hard water stabilizer (D) having the criteria according to the invention to the aqueous coolants.

### Alkylene Glycol, Alkylene Glycol Monoalkyl Ether or Glycerol (B)

Component (B) has the main freezing point depression effect in the coolants. Said component is monomeric to tetrameric 1,2-ethylene glycols, 1,2-propylene glycols or, more rarely, 1,3-propylene glycols, preferably monomeric to trimeric 1,2-ethylene glycols or 1,2-propylene glycols, particularly preferably monomeric or dimeric 1,2-ethylene glycols, very particularly preferably monomeric 1,2-ethylene glycol, and in each case the mixtures thereof.

The alkylene glycol monoalkyl ethers are the mono-C₁-C₄-alkyl ethers of the abovementioned alkylene glycols, preferably the monomethyl, -ethyl or -n-butyl ethers, particularly preferably the monomethyl or -n-butyl ethers and very particularly preferably the monomethyl ethers.

In addition, glycerol or glycerol oligomers are possible components (B).

Preferred alkylene glycol components or derivatives are particularly monoethylene glycol, diethylene glycol, triethylene glycol, tetraethylene glycol and mixtures thereof, but additionally also monopropylene glycol, dipropylene glycol and mixtures thereof, polyglycols, glycol ethers, for example monoethylene glycol monomethyl ether, diethylene glycol monomethyl ether, triethylene glycol monomethyl ether, tetraethylene glycol monomethyl ether, monoethylene glycol monoethyl ether, diethylene glycol monoethyl ether, triethylene glycol monoethyl ether, tetraethylene glycol monoethyl ether, monoethylene glycol mono-n-butyl ether, diethylene glycol mono-n-butyl ether, triethylene glycol mono-n-butyl ether and tetraethylene glycol mono-n-butyl ether, or glycerol, which are each used alone or as mixtures thereof.

Particular preference is given to monoethylene glycol alone or mixtures of monoethylene glycol as main component, i.e. with a content in the mixture of more than 50% by weight, in particular of more than 80% by weight, especially of more than 95% by weight, with other alkylene glycols or derivatives of alkylene glycols.

Phosphate, Carbonate and/or Sulfate (C)

Anions (C) are those compounds which may form precipitates together with alkaline earth metal ions, particularly calcium or magnesium cations, in the concentrations present in the coolants and under the conditions in the cooling system.

The phosphates are used as the free acid (H₃PO₄), as hydrogenphosphate, dihydrogenphosphate or phosphate, particularly as alkali metal salts, particularly preferably as the sodium or potassium salts. The acidic protons in the phosphates may be partially or completely replaced by alkali metal salts.

It is also conceivable to use the corresponding diphosphates, triphosphates or oligophosphates, also in mixtures with monophosphates, however they are preferably used as monomeric phosphates.

Preference is given to the use as the free acid (H₃PO₄), disodium hydrogenphosphate or trisodium phosphate.

The same applies to the carbonates, which may be present as alkali metal salts, preferably the sodium or potassium salts of carbonate or hydrogencarbonate.

The same applies to the sulfates, which may be present as alkali metal salts, preferably the sodium or potassium salts of sulfate or hydrogensulfate.

Carbonates and/or sulfates are generally not added to the coolants or coolant concentrates, but are present in the water (A) used for dilution.

Among compounds (C), preference is given to carbonates and/or phosphates, particular preference is given to the phosphates.

### Hard Water Stabilizer (D)

The hard water stabilizer (D) comprises, preferably consists of, at least one homo- or copolymer that comprises acrylic acid and/or methacrylic acid and/or maleic acid and/or itaconic acid in polymerized form, has a weight-average molecular weight Mw, determined by GPC, of at least 3000 g/mol, preferably at least 3500, particularly preferably at least 4000 and very particularly preferably at least 4500 g/mol, and additionally has a loss of mass in the range of 200° C. to 300° C. of not more than 10%, preferably not more than 8%, particularly preferably not more than 7%, very particularly preferably not more than 5%, in particular not more than 3% and especially not more than 2% by weight.

Said hard water stabilizer (D) is preferably a homo- or copolymer that comprises acrylic acid and/or methacrylic acid and/or maleic acid in polymerized form, particularly preferably a homo- or copolymer that comprises acrylic acid and/or maleic acid in polymerized form and very particularly preferably a homo- or copolymer comprising acrylic acid in polymerized form.

To prepare such homo- or copolymers, a monoethylenically unsaturated C₃-C₅ carboxylic acid is polymerized under the conditions specified below.

Both mono- and dicarboxylic acids are suitable, for example acrylic acid, methacrylic acid, crotonic acid, vinylacetic acid, maleic acid, fumaric acid, aconitic acid, itaconic acid, mesaconic acid, citraconic acid and methylenemalonic acid. Preference is given to preparing homopolymers of acrylic acid, methacrylic acid, maleic acid or itaconic acid, or copolymers of acrylic acid and methacrylic acid, copolymers of acrylic acid and maleic acid and copolymers of acrylic acid and itaconic acid, copolymers of methacrylic acid and maleic acid and copolymers of methacrylic acid and itaconic acid. The carboxylic acids mentioned may be copolymerized with one another in any desired ratio. It is of course possible to also copolymerize three or four different carboxylic acids with one another instead of two of the carboxylic acids mentioned.

The carboxylic acids mentioned may optionally be subjected to polymerization with carboxyl group-free copolymerizable ethylenically unsaturated monomers. Examples of suitable comonomers which, depending on the solubility of the copolymer formed, are used in the polymerization are amides, nitriles or esters of ethylenically unsaturated C₃ to C₅ carboxylic acids, for example acrylamide, methacrylamide, methyl acrylate, methyl (meth)acrylate, ethyl acrylate, ethyl (meth)acrylate, hydroxyethyl acrylate, hydroxyethyl (meth)acrylate, hydroxypropyl acrylate, hydroxypropyl (meth)acrylate, butane-1,4-diol monoacrylate, butane-1,4-diol mono(meth)acrylate, dimethylaminoethyl acrylate, dimethylaminoethyl (meth)acrylate, diethylaminoethyl acrylate, diethylaminoethyl (meth)acrylate, and vinyl esters, for example vinyl acetate, vinyl propionate and vinyl butyrate, and 2-acrylamido-2-methylpropanesulfonic acid, vinylsulfonic acid, allylsulfonic acid, vinyl glycol, allyl alcohol, ethylene, propylene, styrene, methylstyrene and butadiene.

Of the monomers mentioned, use is preferably made of vinyl acetate, diethylaminoethyl acrylate, dimethylaminoethyl acrylate, hydroxyethyl (meth)acrylate, hydroxypropyl (meth)acrylate and methyl acrylate.

The basic acrylates, such as dimethylaminoethyl acrylate, are used either in the form of the salts or of the quaternized compounds, for example quaternized with benzyl chloride or methyl chloride. This group of comonomers serves to modify the carboxyl group-comprising polymers and accounts for 0% to 40% by weight of the structure of the copolymers.

The monomers are polymerized in aqueous solution using polymerisation initiators, preferably water-soluble initiators, for example sodium persulfate, potassium persulfate, ammonium persulfate, hydrogen peroxide, azobis(2-aminopropane) hydrochloride, 2,2-azobis(N,N′-dimethylenisobutyramidine) dihydrochloride and 2,2-azobis(4-cyanopentanoic acid).

The initiators are used either alone or in a mixture, for example mixtures of hydrogen peroxide and sodium persulfate. In addition to the water-soluble initiators, use may also be made of organic peroxides, hydroperoxides and azo compounds that are only sparingly soluble in water.

Examples include the following compounds:

### tert-butyl perpivalate, 2,2-azobis(valeronitrile), tert-butyl per-2-ethylhexanoate, 2,2′-azobis(isobutyronitrile), tert-butyl perbenzoate, tert-butyl hydroperoxide and p-menthane hydroperoxide

The monomers may also be polymerized using redox catalysts. For this purpose, reducing agents used are for example ascorbic acid, benzoin, dimethylaniline and optionally in addition soluble complexes and salts of heavy metals. As is known, this makes it possible to perform the polymerization at a relatively low temperature.

The temperatures in the polymerization are between 60° C. and 160° C., preferably between 80° C. and 130° C. At temperatures above 100° C., it is of course necessary to perform the polymerization under pressure. The concentrations of monomers in the aqueous solutions are 20% to 70%, preferably 35% to 60% by weight.

The molecular weight Mw of compounds (D) may be up to 100 000 g/mol, preferably up to 75 000, particularly preferably up to 50 000, very particularly preferably up to 25 000 and in particular up to 10 000 g/mol.

An additional feature of compounds (D) is a loss of mass, measured by thermogravimetry in the temperature range of 30° C. to 800° C. at a heating rate of 5 K/min in an argon atmosphere at a flow volume of 40 mi/min, of compounds (D) in the temperature range of 200° C. to 300° C. of not more than 10%, preferably not more than 8%, particularly preferably not more than 7%, very particularly preferably not more than 5%, in particular not more than 3% and especially not more than 2% by weight.

In the temperature range below 200° C., the behaviour of the compounds in the thermogravimetry is determined by evaporation of the water in which the homo- or copolymer is in as a result of production.

At temperatures above 300° C., especially above 325° C. and in particular above 350° C., the homo- or copolymer appears to thermally decompose under the described conditions of the thermogravimetry.

In contrast, the temperature range of 200° C. to 300° C. exhibits a good correlation with the formation of precipitates, see below in the examples.

Particularly preferred as compounds (D) are homo- or copolymers comprising acrylic acid in polymerized form having a weight-average molecular weight Mw, determined by GPC, of at least 3500 g/mol to 25 000 g/mol and a loss of mass of not more than 3% by weight, very particularly preferably having a weight-average molecular weight of at least 4000 g/mol to 10 000 g/mol and a loss of mass of not more than 2% by weight.

Without wishing to be bound to any theory, it is assumed that the homo- and copolymers having the minimum molecular weights described, as a measure of the degree of polymerization, have a sufficient number of carboxyl groups with which the alkaline earth metal ions can firstly be complexed and secondly kept in solution in the aqueous medium. The low loss of mass according to thermogravimetry is a measure of the temperature stability of the hard water stabilizers in the critical temperature range in the cooling system when the coolant is exposed to increased wall temperatures. The hard water stabilizers (D) to be used according to the invention are not significantly decomposed at the high wall temperatures of modern internal combustion engines, are therefore capable of complexing alkaline earth metal ions and keeping them in solution, and thus reduce or prevent precipitates of sparingly soluble alkaline earth metal compounds.

### Further Optional Inhibitors and Typical Coolant Constituents

The further inhibitors and typical coolant constituents are each optional independently of one another and selected from the group consisting of
(E) azole compounds,
(F) inorganic compounds other than compounds (C) selected from the group consisting of silicates, borates, nitrates and molybdates,
(G) organic carboxylic acids,
(H) defoamers, dyes and bitter substances, and
(I) inorganic bases.

### Azole Compounds (E)

In the context of this document, azole derivatives (E) are understood to mean five-membered heterocyclic compounds having 2 or 3 heteroatoms from the group of nitrogen and sulfur which comprise no sulfur atoms or at most one sulfur atom incorporated in the ring and which may optionally bear an aromatic or saturated six-membered fusion.

These five-membered heterocyclic compounds (azole derivatives) usually comprise as heteroatoms two N atoms and no S atom, 3 N atoms and no S atom or one N atom and one S atom.

Preferred groups of the azole derivatives mentioned are fused imidazoles and fused 1,2,3-triazoles of the general formula

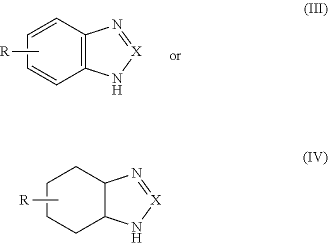

in which the variable
R is hydrogen or a C₁- to C₁₀-alkyl radical, in particular methyl or ethyl, and the variable X is a nitrogen atom or the C—H moiety.

Typical and preferred examples of azole derivatives of the general formula (III) are benzimidazole (X═C—H, R═H), benzotriazole (X═N, R═H) and tolyltriazole (X═N, R═CH₃). A typical example of an azole derivative of the general formula (IV) is hydrogenated 1,2,3-tolyltriazole (X═N, R═CH₃).

A further preferred group of the azole derivatives mentioned is that of the benzothiazoles of the general formula (V)

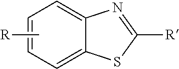

in which
the variable R has the definition given above and
the variable R′ is hydrogen, a C₁ to C₁₀-alkyl radical, in particular methyl or ethyl, or in particular a mercapto group (—SH). Conceivably, albeit less preferably, R′ may also be a carboxyalkyl radical of formula —(CₘH₂ₘ)—COOR″, where m is a number from 1 to 4 and R″ is hydrogen or C₁- to C₁₀-alkyl, in particular methyl or ethyl, or C₈- to C₁₂-aryl. Examples of these are (2-benzothiazylthio)acetic acid, (2-benzothiazylthio)acetic esters, 3-(2-benzothiazylthio)propionic acid or 3-(2-benzothiazylthio)propionic esters. If these compounds are used in acid form, they are not among the carboxylic acids excluded according to the invention. A typical example of an azole derivative of the general formula (V) is 2-mercaptobenzothiazole.

Further preferred are non-fused azole derivatives of the general formula (VI)

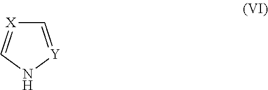

in which the variables
X and Y are together two nitrogen atoms or
a nitrogen atom and a C—H moiety,
for example 1H-1,2,4-triazole (X═Y=N) or preferably imidazole (X═N, Y═C—H).

Very particularly preferred as azole derivatives for the present invention are benzimidazole, benzotriazole, tolyltriazole, hydrogenated tolyltriazole or mixtures thereof, in particular benzotriazole or tolyltriazole, especially tolyltriazole.

The azole derivatives mentioned are commercially available or are producible by common methods. Hydrogenated benzotriazoles such as hydrogenated tolyltriazole are likewise obtainable according to DE-A 1 948 794 and are also commercially available.

The azoles are preferably selected from the group consisting of benzotriazole, tolyltriazole, (2-benzothiazylthio)acetic acid, 3-(2-benzothiazylthio)propionic acid and 2-mercaptobenzothiazole.

Inorganic Compounds Other than Compounds (C) Selected from the Group Consisting of Silicates, Borates, Nitrates and Molybdates (F) The inorganic inhibitors (F) are silicates, borates, nitrates or molybdates, or mixtures thereof in the form of their free acids or their salts, particularly their alkali metal salts, particularly preferably their sodium or potassium salts. The form (in protonated or salt form) in which they are used in the compositions, superconcentrates, concentrates or coolants depends on the respective pKₐ of the compound and of the composition and the pH of the respective medium which is established by the amount of base (D).

The inorganic silicates act predominantly as inhibitors of the corrosion of aluminum and are usually used as alkali metal salts or, more rarely, as magnesium, calcium or aluminum salts, preferably as sodium or potassium salts.

The silicates are preferably selected from the group consisting of orthosilicates (SiO₄⁴⁻), metasilicates (SiO₃²⁻), and pyrosilicates (Si₂O₇⁶⁻), and particularly preferably are metasilicates (SiO₃²⁻), very particularly preferably sodium metasilicate (Na₂SiO₃) or potassium metasilicate (K₂SiO₃), in particular sodium metasilicate (Na₂SiO₃).

Instead of or in addition to the inorganic silicates mentioned, the coolants may also comprise organic ortho-silicic esters of the general formula Si(OR)₄, in which each R is independently C₁-C₄-alkyl, preferably methyl, ethyl or n-butyl, particularly preferably methyl or ethyl or mixtures of methyl and ethyl.

If the composition according to the invention comprises at least one silicate, then in a preferred embodiment at least one silicophosphonate is added in addition to the silicate, as described in the unpublished European patent application with the application number 20213979.6 and the filing date Dec. 15, 2020.

The silicophosphonate is preferably a compound of the general formula

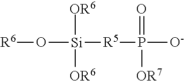

in which
R⁵ is a divalent organic radical, preferably a 1, ω-alkylene group having 1 to 6, preferably 1 to 4, carbon atoms, particularly preferably methylene, 1,2-ethylene, 1,2-propylene, 1,3-propylene or 1,4-butylene, very particularly preferably 1,2-ethylene or 1,3-propylene, and in particular 1,2-ethylene,
R⁶ is independently hydrogen, C₁- to C₄-alkyl or hydroxy-C₂- to -C₄-alkyl, preferably hydrogen, methyl, ethyl, n-propyl, isopropyl, n-butyl, isobutyl, sec-butyl or tert-butyl, 2-hydroxyethyl or 2-hydroxypropyl, particularly preferably hydrogen, methyl, ethyl or propyl, and R⁷ is C₁ to C₄-alkyl, preferably methyl, ethyl, n-propyl or n-butyl, particularly preferably methyl, ethyl or n-butyl, very particularly preferably methyl or ethyl and in particular methyl.

The silicophosphonates may be used as the free acid or as an alkali metal salt, preferably as the sodium or potassium salt and particularly preferably as the sodium salt.

The borates are preferably used as sodium tetraborate (borax) or as potassium tetraborate, particularly preferably as sodium tetraborate.

The nitrates are used as alkali metal or alkaline earth metal nitrates, preferably as sodium nitrate, potassium nitrate or magnesium nitrate, preferably as sodium nitrate or potassium nitrate, particularly preferably as sodium nitrate.

Components (F) are preferably at least one compound selected from the group consisting of silicates, borates or nitrates, particularly preferably at least one compound selected from the group consisting of silicates or nitrates.

### Organic Carboxylic Acids (G)

The organic carboxylic acids may be organic monocarboxylic acids (G1) or dicarboxylic acids (G2), preferably monocarboxylic acids having 2 to 18 carbon atoms and organic dicarboxylic acids having 4 to 20 carbon atoms,

(G1) Monocarboxylic acids having 2 to 18 carbon atoms

Suitable monocarboxylic acids (G1) may be linear or branched aliphatic, cycloaliphatic or aromatic monocarboxylic acids having 2 to 18 carbon atoms, preferably having 5 to 16, particularly preferably having 5 to 15, very particularly preferably having 6 to 12 and in particular having 8 to 10 carbon atoms.

Branched aliphatic monocarboxylic acids are preferred over the corresponding linear monocarboxylic acids.

Examples of suitable linear or branched aliphatic monocarboxylic acids (G1) are propionic acid, pentanoic acid, 2,2-dimethylpropanoic acid, hexanoic acid, 2,2-dimethylbutanoic acid, cyclohexyl acetic acid, octanoic acid, 2-ethylhexanoic acid, nonanoic acid, isononanoic acid, decanoic acid, undecanoic acid and dodecanoic acid.

One particularly suitable aromatic monocarboxylic acid (G1) is benzoic acid; also suitable are C₁-C₈-alkylbenzoic acids such as o-, m-, p-methylbenzoic acid or p-tert-butylbenzoic acid, as are hydroxy group-containing aromatic monocarboxylic acids such as o-, m-, p-hydroxybenzoic acid, o-, m-, p-(hydroxymethyl)benzoic acid, or halobenzoic acids such as o-, m-, p-fluorobenzoic acid.

Particularly preferred monocarboxylic acids are 2-ethylhexanoic acid and isononanoic acid.

In the context of this document, isononanoic acid describes one or more branched aliphatic monocarboxylic acids having 9 carbon atoms. Isomers which should be given particular emphasis are 7-methyloctanoic acid (for example CAS No. 693-19-6 and 26896-18-4), 6,6-dimethylheptanoic acid (for example CAS No. 15898-92-7), 3,5,5-trimethylhexanoic acid (for example CAS No. 3302-10-1), 3,4,5-trimethylhexanoic acid, 2,5,5-trimethylhexanoic acid, 2,2,4,4-tetramethylpentanoic acid (for example CAS No. 3302-12-3) and mixtures containing such isomers or mixtures thereof. In a preferred embodiment, an isononanoic acid isomer mixture comprises, as main component to an extent of more than 90% by weight, 7-methyloctanoic acid, 6,6-dimethylheptanoic acid, 3,5,5-trimethylhexanoic acid, 3,4,5-trimethylhexanoic acid, 2,5,5-trimethylhexanoic acid and 2,2,4,4-tetramethylpentanoic acid. The remainder is formed by other isomers of monocarboxylic acids having 9 carbon atoms and minor impurities. In a further preferred embodiment, the isononanoic acid comprises 3,5,5-trimethylhexanoic acid to an extent of more than 90% by weight, particularly preferably to an extent of at least 95% by weight, (G2) Organic dicarboxylic acid having 4 to 20 carbon atoms

The organic dicarboxylic acids having 4 to 20 carbon atoms are linear or branched alkanedicarboxylic acids, preferably linear alkane- or alkenedicarboxylic acids, particularly preferably alkanedicarboxylic acids, particularly preferably having 5 to 14 and very particularly preferably having 6 to 12 carbon atoms.

The dicarboxylic acids (G2) are preferably selected from the group consisting of succinic acid, maleic acid, fumaric acid, glutaric acid, adipic acid, pimelic acid (heptanedioic acid), azelaic acid (nonanedioic acid), sebacic acid (decanedioic acid), undecanedioic acid, dodecanedioic acid, and alkyl- and alkenylsuccinic acids and -glutaric acids such as 2-methylbutanedioic acid, 2-ethyl-3-methylbutanedioic acid, 2-ethylpentanedioic acid, 2-dodecylbutanedioic acid, 2-dodecenylbutanedioic acid, 2-phenylbutanedioic acid, 2-(p-methylphenyl)butanedioic acid, 2,2-dimethylbutanedioic acid, 2,3,4-trimethylpentanedioic acid, 2,2,3-trimethylpentanedioic acid, glutaconic acid (pent-2-enedioic acid), itaconic acid, hex-2-enedioic acid, hex-3-enedioic acid, 5-methylhex-2-enedioic acid and 2,3-dimethylpent-2-enedioic acid.

Among these, preference is given to the dicarboxylic acids having 6 to 12 carbon atoms, particular preference among these to the alkanedicarboxylic acids having 6 to 12 carbon atoms, very particular preference to the linear alkanedicarboxylic acids having 6 to 12 carbon atoms.

Especially preferred as dicarboxylic acids (G2) are adipic acid, sebacic acid, azelaic acid and dodecanedicarboxylic acid.

Defoamers, Dyes and/or Bitter Substances (H)

As further customary auxiliaries, the compositions according to the invention may also comprise, in customary small amounts, defoamers (generally in amounts of 0.003% to 0.008% by weight in the ready-diluted coolant) and, for reasons of hygiene and safety in the event that it is swallowed, bitter substances (for example of the denatonium benzoate type) and dyes.

### Inorganic Bases (I)

The pH of the finished coolants is usually in the range from 4 to 11.5, preferably 5 to 10, in particular 6 to 9.

Therefore, the coolants optionally comprise an amount of inorganic base which establishes this desired pH in the coolant in the case of appropriate dilution. For this purpose, the compositions according to the invention preferably comprise alkali metal hydroxide, particularly preferably solid lithium hydroxide, sodium hydroxide or potassium hydroxide, optionally also in the form of aqueous lithium hydroxide, sodium hydroxide or potassium hydroxide solution.

Less preferred are carbonates or hydrogencarbonates of lithium, sodium or potassium.

Preferred alkali metals are sodium and potassium.

Typically, the coolants are composed as follows:
at least 40% by weight of water (A)
at least 30% by weight of alkylene glycol, alkylene glycol monoalkyl ether and glycerol (B),
001% to 5% by weight, preferably 0.02% to 2% and particularly preferably 0.03% to 1% by weight of at least one phosphate, carbonate and/or sulfate (C)
0.1% to 2% by weight of at least one hard water stabilizer (D)
0% to 2%, preferably 0.05% to 1% and particularly preferably 0.1% to 0.5% by weight of at least one azole (E)
0% to 5% by weight, preferably 0.01% to 2% and particularly preferably 0.02% to 1% by weight of at least one inorganic compound (F) selected from the group consisting of silicates, borates, nitrates and molybdates
0% to 6% by weight, preferably 1% to 5% and particularly preferably 2% to 4% by weight of at least one organic carboxylic acid (G),
0% to 0.2%, preferably 0.001% to 0.15% by weight of at least one compound selected from the group consisting of defoamers, dyes and bitter substances, and
0% to 10%, preferably 0.5% to 8% and particularly preferably 1% to 7% by weight of at least one inorganic base, with the proviso that
the sum total of all components is always 100% by weight.

In order to reduce the volumes to be transported, what are sold are usually concentrates in which the water content is omitted or greatly reduced. The coolants are produced by the end user from the concentrates by adding water (A), preferably by adding half to twice the volume of water, particularly preferably by adding the same volume of water.

The present invention thus further provides coolant concentrates, which are typically composed as follows:
not more than 15%, preferably not more than 10% and more preferably not more than 5% by weight of water (A)
at least 60% by weight of alkylene glycol, alkylene glycol monoalkyl ether and glycerol (B), 002% to 10% by weight, preferably 0.04% to 4% and particularly preferably 0.06% to 2% by weight of at least one phosphate, carbonate and/or sulfate (C)
02% to 4% by weight of at least one hard water stabilizer (D)
0% to 4%, preferably 0.1% to 2% and particularly preferably 0.2% to 1% by weight of at least one azole (E)
0% to 10% by weight, preferably 0.02% to 4% and particularly preferably 0.04% to 2% by weight of at least one inorganic compound (F) selected from the group consisting of silicates, borates, nitrates and molybdates
0% to 12% by weight, preferably 2% to 10% and particularly preferably 4% to 8% by weight of at least one organic carboxylic acid (G), 0% to 0.4%, preferably 0.002% to 0.3% by weight of at least one compound selected from the group consisting of defoamers, dyes and bitter substances, and
0% to 20%, preferably 1% to 16% and particularly preferably 2% to 14% by weight of at least one inorganic base,
with the proviso that
the sum total of all components is always 100% by weight.

In order to further reduce the volumes to be transported, what are called superconcentrates are often produced centrally, in which not only the water content but additionally also the glycol content is omitted or greatly reduced. These superconcentrates are then used only regionally by formulators, by blending with glycols, to produce the concentrates.

The superconcentrates differ from the concentrates in that they are completely or partially missing component (B), therefore the other components are present in a correspondingly higher concentration. The concentrates in the abovementioned concentration are thus obtained from such superconcentrates by admixing with component (B).

The compositions described are used as coolants for the removal of heat in internal combustion engines or a hybrid of fuel cells and/or batteries with internal combustion engines in which the cooling system for cooling the internal combustion engine comprises the coolant according to the invention.

As a result of the compositions described having a higher thermal stability than coolants comprising conventional hard water stabilizers, the present invention further provides a method for cooling internal combustion engines, in which heat from a heat source at a relatively high temperature is transferred to a coolant via at least one first heat exchanger, this coolant is passed in a cooling circuit to at least one second heat exchanger and in said second heat exchanger heat is removed from the coolant at a relatively low temperature, in which
a composition as described above is used as coolant,
the relatively high temperature is from 60° C. to 300° C., preferably 70° C. to 280° C., particularly preferably 80° C. to 250° C.,
the relatively low temperature is from minus 50° C. to 100° C., preferably minus 40° C. to 90° C., particularly preferably minus 30° C. to 80° C. and
the relatively low temperature is at least 50° C. lower than the relatively high temperature.

The relatively high temperature here is preferably the wall temperatures of internal combustion engines, for example in vehicles operated only with an internal combustion engine or in hybrid vehicles composed of electric vehicles with fuel cells and/or batteries with internal combustion engines.

The present invention further provides vehicles having an internal combustion engine or a hybrid of fuel cells and/or batteries with internal combustion engines in which the cooling system for cooling the internal combustion engine comprises the coolant according to the invention.

The relatively low temperature here is preferably the ambient temperature with which the heated coolant is brought into contact in the second heat exchanger.

All of the heat exchangers may be components known per se which are known to those skilled in the art for these purposes.

The present invention further provides a general method for increasing the heat transfer at a surface which is at a high wall temperature and which is cooled with a phosphate-, carbonate- and/or sulfate-containing aqueous coolant, in which the phosphate-, carbonate- and/or sulfate-containing aqueous coolant comprises a hard water stabilizer (D) which is at least one homo- or copolymer that comprises acrylic acid and/or methacrylic acid and/or maleic acid and/or itaconic acid in polymerized form, has a weight-average molecular weight Mw, determined by GPC, of at least 3000 g/mol, preferably at least 3500, particularly preferably at least 4000 and very particularly preferably at least 4500 g/mol, and has a loss of mass in the temperature range of 200° C. to 300° C. of not more than 10%, preferably not more than 8%, particularly preferably not more than 7%, very particularly preferably not more than 5%, in particular not more than 3% and especially not more than 2% by weight.

The present invention further provides for the use of hard water stabilizers (D) which are homo- or copolymers that comprise acrylic acid and/or methacrylic acid and/or maleic acid and/or itaconic acid in polymerized form, have a weight-average molecular weight Mw, determined by GPO, of at least 3000 g/mol, preferably at least 3500, particularly preferably at least 4000 and very particularly preferably at least 4500 g/mol, and have a loss of mass in the temperature range of 200° C. to 300° C. of not more than 10%, preferably not more than 8%, particularly preferably not more than 7%, very particularly preferably not more than 5%, in particular not more than 3% and especially not more than 2% by weight in aqueous coolants, in particular in coolants containing phosphate, carbonate and/or sulfate (C).

Amounts reported in percent, ppm or parts in this document relate to % by weight, ppm by weight or parts by weight, unless stated otherwise.

### EXAMPLES

### Thermogravimetry

The change in weight of about 20 mg of a sample of compound (D) in the form of a 50% by weight aqueous solution was determined in an open crucible in the temperature range of 30° C. to 800° C. at a heating rate of 5 K/min in an argon atmosphere at a flow volume of 40 ml/min. The loss of mass in the range of 200° C. to 300° C. as Δm in % by weight has been specified in the tables below, where the mass present at 200° C. was taken as the basis.

MHTA test in accordance with FVV [German Research Association for Combustion Engines]-Test method in accordance with Booklet R 530/2005

The Modular Heat Test Apparatus (MHTA) was developed at the Institute for Materials Science of TU Darmstadt.

To assess the performance of coolant additives under operating conditions, the Modular Heat Test Apparatus (MHTA) is used in accordance with FVV test method Booklet R 530/2005 (Testing the suitability of coolant additives for coolants of internal combustion engines. Booklet R 530/2005 of the FWV, Frankfurt am Main, 2005).

In a deviation from FV Booklet R530/2005, Point 8, Corrosion tests with heat transfer (hot test), the test specimen used was not the test specimen described under 8.2.1, rather a test specimen with a central cooling channel with a diameter of approx. 3.4 mm. These test specimens are obtained commercially from TheSys GmbH based in Kirchentellinsfurt.

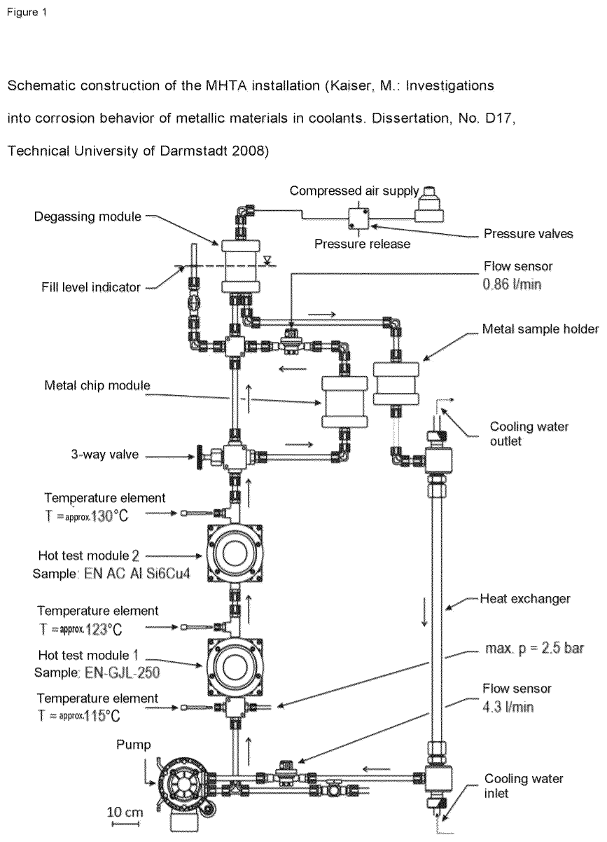

The MHTA, designed as a circulation system (see FIG. 1), consists of several, modularly usable test modules which allow the simulation of practice-oriented load conditions and cycles.

This modular construction enables a differentiated examination of the mechanisms and effectiveness of coolant preparations using various operating conditions. Essentially, the heat flow density or the volume flow of the coolant can be varied independently of one another using various coolants.

In contrast to the actual internal combustion engine, the MHTA makes it possible—through the control of the coolant flow temperature over the cooling zone—to realise constantly high heat flow densities at the heating surfaces, also with a low coolant flow temperature (Christina Berger, Torsten TroRmann, Markus Kaiser, M T Z 2008, 02, volume 69, page 148).

It is thus possible in the MHTA to examine different heat flow densities in the case of various coolant volume flows and various coolants with regard to corrosion behavior and heat removal. The measurement accuracy of this method is approx. +1-2° C.

Coolant formulations used (in % by weight or ppm by weight)

| | |
|---|---|
| Monoethylene glycol | 90.83% |
| Sebacic acid | 3% |
| Isononanoic acid | 0.6% |
| Phosphoric acid 75% | 0.15% |
| Sodium metasilicate | 0.44% |
| Tolyltriazole | 0.15% |
| Defoamer | 50 ppm |
| (2-Benzothiazylthio)acetic acid | 0.15% |
| Sodium molybdate dihydrate | 0.2% |
| Dyes | 50 ppm |
| Bitter substance | 70 ppm |

The aqueous coolant was produced from this by dilution with the same volume of water with the hardness specified in Table 2, and a further 0.3% by weight of the hard water stabilizers specified in Table 2 in the form of a 50% aqueous solution was additionally added to said aqueous coolant.

### Hard Water Stabilizers (HWS) Used

The hard water stabilizers used are commercially available polyacrylic acid or polycarboxylate copolymers, the molecular weight of which and the result Δm from the thermogravimetry are specified in Table 1:

| | Δm [% by weight] | Molecular weight Mw [g/mol] |
|---|---|---|
| HWS1 | −1.4 | 5000 |
| HWS2 | −14.7 | 2500 |
| HWS3 | −1.1 | 1200 |
| HWS4 | −1.3 | 4500 |

### Results of the MHTA Test

TABLE 2

| | Example | | | | | |
|---|---|---|---|---|---|---|
| | | | 3 | 4 | 5 | |
| | 1 | 2 | (comp) | (comp) | (comp) | 6 |
| Water, °dH | 0 | 10 | 10 | 10 | 10 | 10 |
| Hard water | HWS1 | HWS1 | — | HWS2 | HWS3 | HWS4 |
| stabilizer | | | | | | |
| Test duration, h | 30 | 30 | 0 | 30 | 30 | 30 |
| Temperature of | 210 | 210 | Discon- | 226 | 250 | 212 |
| the test plate | | | tinued | | | |
| after 5 h | | | | | | |
| [° C.] | | | | | | |
| Temperature of | 214 | 220 | Discon- | 228 | 262 | 214 |
| the test plate | | | tinued | | | |
| after 30 h | | | | | | |
| [° C.] | | | | | | |

Example 1 was performed with distilled water in order to determine the effect of a thermal load on the coolant in the absence of Ca²⁺ and Mg²⁺ cations.

It can be seen that a thermal equilibrium is established at a temperature of 210° C. 5 hours after the start of the test in the case of a deposit-free test plate. In the course of the test over a period of 30 hours, this initial temperature increases by +4° C., which can be attributed to a reduction in heat transfer due to formation of deposits that are not based on alkaline earth metal compounds, for example the build-up of an anti-corrosion layer as a result of the corrosion inhibitors.

In Example 3, a coolant comprising alkaline earth metal ion-containing water was examined in the absence of a hard water stabilizer. A deposit formed on the test plate which impaired the heat transfer to such an extent that the temperature of the test plate rose to 316° C., with the result that the test apparatus switched itself off.

A chemical analysis of the deposit showed that it consisted of a mixture of calcium phosphate and magnesium phosphate.

In Examples 4 and 5, coolants comprising alkaline earth metal ion-containing water were examined in the presence of hard water stabilizers not having the molecular weight required according to the invention (HWS3) or not fulfilling the thermogravimetry criterion (HWS2).

It can be seen that the initial temperatures of the test plate are significantly above the starting temperature of the zero value from Example 1, which suggests less favorable heat transfer.

Even though the temperature increase over the test duration is only +2° C. in the case of Example 4, the heat transfer remains unfavorable.

In Examples 2 and 6, the hard water stabilizers HWS1 and HWS4 according to the invention which fulfill both criteria (molecular weight and thermogravimetry) are used.

The starting temperature corresponds to that of Example 1 within the scope of the measurement accuracy and also only increases in the course of the test by +10° C. or +2° C., respectively.

This shows that the heat transfer which was already good at the start is essentially maintained even in the case of thermal load on the coolant. Even in the case of thermal load, the hard water stabilizers used were capable of complexing the alkaline earth metal ions in the water and of keeping them in solution, with the result that no significant deposits composed of alkaline earth metal compounds formed in the course of the test. The increase in the observed temperature does not go beyond (Example 6) or hardly goes beyond (Example 2) that of the zero sample (Example 1).

1: An aqueous coolant, comprising:
(A) water,
(B) at least one alkylene glycol, alkylene glycol monoalkyl ether, or glycerol,
(C) at least one phosphate, carbonate, and/or sulfate in the form of its free acids or its salts,
(D) at least one hard water stabilizer, and
optionally, further inhibitors and typical coolant constituents,
wherein the at least one hard water stabilizer (D) is at least one homo- or copolymer that comprises acrylic acid and/or methacrylic acid and/or maleic acid and/or itaconic acid in polymerized form, has a weight-average molecular weight Mw, determined by GPC, of at least 3000 g/mol, and has a loss of mass in the temperature range of 200° C. to 300° C. of not more than 10% by weight,
wherein the loss of mass is measured by thermogravimetry in the temperature range of 30° C. to 800° C. at a heating rate of 5 K/min in an argon atmosphere at a flow volume of 40 ml/min, wherein a mass present at 200° C. is taken as a reference value and a decrease with further heating up to 300° C. is taken as the loss of mass.

2: The aqueous coolant according to claim 1, wherein the water (A) is water comprising alkaline earth metal ions.

3: The aqueous coolant according to claim 1, wherein component (B) is selected from the group consisting of monomeric to tetrameric 1,2-ethylene glycols, 1,2-propylene glycols, 1,3-propylene glycols, the mono-C₁-C₄-alkyl ethers thereof, and glycerol.

4: The aqueous coolant according to claim 1, wherein component (B) is 1,2-ethylene glycol.

5: The aqueous coolant according to claim 1, wherein component (C) is selected from the group consisting of monophosphates, diphosphates, triphosphates, oligophosphates, carbonates, hydrogencarbonates, sulfates, hydrogensulfates as the free acid, and an alkali metal salt.

6: The aqueous coolant according to claim 1, additionally comprising at least one azole derivative (E).

7: The aqueous coolant according to claim 1, additionally comprising at least one inorganic inhibitor (F) selected from the group consisting of silicates, borates, nitrates, moly bdates, and mixtures thereof in the form of their free acids or their salts.

8: The aqueous coolant according to claim 1, additionally comprising at least one monocarboxyiic acid (G1) having 2 to 18 carbon atoms and/or at least one organic dicarboxylic acid (G2) having 4 to 20 carbon atoms.

9: The aqueous coolant according to claim 1, additionally comprising at least one organic carboxylic acid (G) selected from the group consisting of propionic acid, pentanoic acid, 2,2-dimethylpropanoic acid, hexanoic acid, 2,2-dimethylbutanoic acid, cyclohexyl acetic acid, octanoic acid, 2-ethylhexanoic acid, nonanoic acid, isononanoic acid, decanoic acid, undecanoic acid, dodecanoic acid, succinic acid, maleic acid, fumaric acid, glutaric acid, adipic acid, pimelic acid (heptanedioic acid), azelaic acid (nonanedioic acid), sebacic acid (decanedioic acid), undecanedioic acid, dodecanedioic acid, alkyl- and alkenylsuccinic acids and -glutaric acids, 2-methylbutanedioic acid, 2-ethyl-3-methylbutanedioic acid, 2-ethylpentanedioic acid, 2-dodecylbutanedioic acid, 2-dodecenylbutanedioic acid, 2-phenylbutanedioic acid, 2-(p-methylphenyl)butanedioic acid, 2,2-dimethylbutanedioic acid, 2,3,4-trimethylpentanedioic acid, 2,2,3-trimethylpentanedioic acid, glutaconic acid (pent-2-enedioic acid), itaconic acid, hex-2-enedioic acid, hex-3-enedioic acid, 5-methylhex-2-enedioic acid, and 2,3-dimethylpent-2-enedioic acid.

10: The aqueous coolant according to claim 1, having a pH of 4 to 11.5 established with lithium hydroxide, sodium hydroxide, or potassium hydroxide.

11: The aqueous coolant according to claim 1, comprising:
at least 40% by weight of water (A),
at least 30% by weight of the at least one alkylene glycol, alkylene glycol monoalkyl ether, or glycerol (B),
0.01% to 5% by weight of the at least one phosphate, carbonate, and/or sulfate (C),
0.1% to 2% by weight of the at least one hard water stabilizer (D),
0% to 2% by weight of at least one azole (E),
0% to 5% by weight of at least one inorganic compound (F) selected from the group consisting of silicates, borates, nitrates, and molybdates,
0% to 6% by weight of at least one organic carboxylic acid (G),
0% to 0.2% by weight of at least one compound selected from the group consisting of defoamers, dyes, and bitter substances, and
0% to 10% by weight of at least one inorganic base,
with the proviso that
the sum total of all components is always 100% by weight.

12: A coolant concentrate for producing the aqueous coolant according to claim 1, comprising:
not more than 15% by weight of water (A),
at least 60% by weight of the at least one alkylene glycol, alkylene glycol monoalkyl ether, or glycerol (B),
0.02% to 10% by weight of the at least one phosphate, carbonate, and/or sulfate (C),
0.2% to 4% by weight of the at least one hard water stabilizer (D),
0% to 4% by weight of at least one azole (E),
0% to 10% by weight, of at least one inorganic compound (F) selected from the group consisting of silicates, borates, nitrates, and molybdates,
0% to 12% by weight of at least one organic carboxylic acid (G),
0% to 0.4% by weight of at least one compound selected from the group consisting of defoamers, dyes, and bitter substances, and
0% to 2% by weight of at least one inorganic base,
with the proviso that
the sum total of all components is always 100% by weight.

13: A method for cooling internal combustion engines, the method comprising:
transferring heat from a heat source at a relatively high temperature to a coolant via at least one first heat exchanger, wherein this coolant is passed in a cooling circuit to at least one second heat exchanger, and in said second heat exchanger heat is removed from the coolant at a relatively low temperature,
wherein
the aqueous coolant according to claim 1 is used as the coolant,
the relatively high temperature is from 60° C. to 300° C.,
the relatively low temperature is from minus 50° C. to 100° C., and
the relatively low temperature is at least 50° C. lower than the relatively high temperature.

14: A method for increasing the heat transfer at a surface which is at a high wall temperature, the method comprising:
cooling the surface with a phosphate-containing aqueous coolant,
wherein the phosphate-containing aqueous coolant comprises a hard water stabilizer (D) which is at least one homo- or copolymer that comprises acrylic acid and/or methacrylic acid and/or maleic acid and/or itaconic acid in polymerized form, has a weight-average molecular weight Mw, determined by GPC, of at least 3000 g/mol, and has a loss of mass in the temperature range of 200° C. to 300° C. of not more than 10% by weight.

15: A method for reducing or preventing precipitates of alkaline earth metal compounds from phosphate-containing, aqueous coolants, the method comprising:
adding to the aqueous coolants at least one hard water stabilizer (D), which is at least one homo- or copolymer that comprises acrylic acid and/or methacrylic acid and/or maleic acid and/or itaconic acid in polymerized form, has a weight-average molecular weight Mw, determined by GPC, of at least 3000 g/mol, and has a loss of mass in the temperature range of 200° C. to 300° C. of not more than 10% by weight.

16: An internal combustion engine or a hybrid of fuel cells and/or batteries with the internal combustion engine, comprising a cooling system for cooling the internal combustion engine, wherein the cooling system comprises the aqeuous coolant according to claim 1.

17. (canceled)

18: A vehicle having an internal combustion engine or a hybrid of fuel cells and/or batteries with the internal combustion engine, wherein a cooling system for cooling the internal combustion engine comprises the aqueous coolant according to claim 1.

19: The aqueous coolant according to claim 1, wherein the at least one hard water stabilizer (D) has a weight-average molecular weight Mw, determined by GPC, of at least 4,500 g/mol, and has a loss of mass in the temperature range of 200° C. to 300° C. of not more than 2% by weight.

20: The aqueous coolant according to claim 1, wherein component (C) is at least one phosphate, carbonate, and/or sulfate in the form its sodium or potassium salts.

21: The aqueous coolant according to claim 6, wherein the at least one azole derivative (E) is selected from the group consisting of benzimidazole, benzotriazole, tolyltriazole, 2-mercaptobenzothiazole, (2-benzothiazylthio)acetic acid, and 3-(2-benzothiazylthio)propionic acid.
